(19) United States
(12) Patent Application Publication
(10) Pub. No.: US 2020/0370699 A1
(43) Pub. Date: Nov. 26, 2020

(54) Device and Method for Repairing Pipe

(71) Applicant: LMK Technologies, LLC, Ottawa, IL (US)

(72) Inventor: Rick Gage, Ottawa, IL (US)

(73) Assignee: LMK Technologies, LLC, Ottawa, IL (US)

(21) Appl. No.: 16/420,276

(22) Filed: May 23, 2019

(51) Int. Cl. F16L 55/18

(52) U.S. Cl. CPC F16L 55/18

(57) ABSTRACT

An assembly and method are provided for repairing either a single pipe line or a main pipe line having a lateral pipe line connected thereto. The assembly includes a liner impregnated with a liquid material capable of curing and hardening. The liner is combined with a band assembly having a first band member and a second band member combined with connecting members. The band assembly helps forma tight seal between the liner and the pipe line.

### BACKGROUND

The present invention relates to a device and method for repairing pipe, such as underground sewer pipe and the like.

Prior methods for repairing damaged pipe lines include moving a liner tube impregnated with a liquid material capable of curing and hardening to the position within the pipe where the damaged portion is located. The liner tube is urged in an outward radial direction into contact with the pipe line being repaired and the liquid material impregnating the liner tube is permitted to cure and harden. The liner tube forms an interior liner in the pipe for the pipe line being repaired.

On some occasions lateral pipe lines are connected to main pipe lines. Often damage occurs at the junction between the lateral pipe line and the main pipe line. T-shaped or Y-shaped liner tubes have been utilized to fit within the junction between the lateral pipe line and the main pipe line. Liner tubes form a T-shaped or Y-shaped liner after hardening to the interior of the junction between the lateral pipe line and the main pipe line.

Ground water outside the lateral pipe line and the main pipe line infiltrates through the damaged portion of the pipe line and migrates between the liner tube and the pipe line to a point where it can enter the pipe line. In order to prevent this infiltration of ground water, attempts have been made to adhere the liner tube to the interior surface of the pipe line being repaired, whether it is a single straight pipe line or a T-shaped or Y-shaped pipe line.

However, considerable difficulty has been encountered in attempting to obtain an adhesive bond between the liner tube and the interior of the pipe being repaired. The interior of the pipe being repaired is often greasy or oily even after high pressure water jetting is performed. Attempts have been made to wash the interior of the pipe line with some success, but washing the interior of the pipe line is often only partial and not reliable. Furthermore, in some types of pipes, such as polyethylene pipes, an adhesive bond cannot be maintained between the resin impregnated liner tube and the polyethylene pipe even if the pipe is free from grease and oils.

Even in those instances where the interior of the pipe line is suitable for accepting a liner, shrinkage of the liner can occur, which creates a gap that allows ground water to flow around the liner and eventually infiltrate the pipe line. For example, thermoset resins are used in cured-in-place pipe applications to form the liner to the interior of the pipe line. These thermoset resins tend to shrink during the curing process, thus creating a gap between the liner and the pipe. Even the slightest shrinkage in the liner can be problematic.

A primary object of the present invention is the provision of an improved device and method for repairing pipe by using hydrophilic seals or other impermeable compressible materials.

A further object of the present invention is the provision of a band assembly made from a hydrophilic, hydrophobic, or other impermeable compressible material which includes a first band connected to a second band by connecting members. The first and second bands are positioned generally circumferentially around the outside of the liner and the connecting members extend generally along the length of the liner between the two bands.

A further object of the present invention is the provision of a device and method for preventing ground water from infiltrating a pipe line near the juncture between a main pipe line and a lateral pipe line.

A further object of the present invention is the provision of a device and method for preventing ground water from traveling within a lateral pipe (between the liner and the pipe) near the terminating end of the lateral liner.

A further object of the present invention is the provision of a device and method for repairing a section of a pipe and preventing entry of ground water from a damaged portion of the pipe being repaired.

A further object of the present invention is the provision of a device and method for repairing the juncture between a main pipe line and a lateral pipe line which uses a band assembly having a first hydrophilic band or gasket or similar article of impermeable compressible material positioned between the main pipe line and the liner around the opening that connects the main pipe line to the lateral pipe line. The first hydrophilic band is connected by hydrophilic members to a second hydrophilic band or similar article of impermeable compressible material positioned around the lateral liner.

A further object of the present invention is the provision of a device and method for repairing a lateral pipe by everting a lateral liner into the lateral pipe. A band assembly is placed within the interior of the lateral liner tube before eversion. The band assembly includes a first band connected to a second band by connecting members. The band assembly may be made from a hydrophilic, hydrophobic, or other similar impermeable compressible material that seals against entry of ground water. Upon eversion the band assembly is positioned around the lateral liner.

A further object of the present invention is the provision of a device and method for repairing pipe using a band assembly which is economical to manufacture, durable in use, and reliable in operation.

### SUMMARY

According to one aspect of the invention, an apparatus and method for repairing the junction between a lateral pipe and a main pipe. A band assembly is positioned near the main/lateral liner junction. The band assembly is made of a hydrophilic, hydrophobic or a similar impermeable compressible material. The band assembly includes a first band and a second band connected by connecting members. This apparatus is suitable for use in both inversion-style applications and pull-in-place applications. The first band surrounds the opening between the main and lateral liners and is disposed between the main pipe line and the liner around the periphery of the opening between the main and lateral pipes to effectively seal against entry of ground water at the pipe junction. The second band is positioned within the interior of the lateral liner so that upon inversion (in the embodiments which use inversion) the second band is positioned around the outside of the lateral liner between the lateral liner and the wall of the lateral pipe. In some embodiments the second band is positioned near the terminating end of the lateral liner. Exposing the hydrophilic band assembly to water or other liquid causes it to swell, thereby creating a seal between the liner and the wall of the pipe.

According to another aspect of the invention, an apparatus and method for repairing a lateral pipe by positioning a lateral liner into the lateral pipe. The band assembly may be made from a hydrophilic, hydrophobic, or other similar impermeable compressible material that seals against entry of ground water. The band assembly includes a first band connected to a second band by connecting members. The first and second bands are positioned generally circumferentially around the outside of the lateral liner and the connecting members extend generally along the length of the lateral liner between the two bands. The bands help prevent water from traveling along the length of the pipe and the connecting members help prevent water from traveling around the internal circumference of the pipe. This apparatus is suitable for use in both inversion-style applications and pull-in-place applications. In embodiments which use inversion, the band assembly is placed within the interior of the lateral liner tube before eversion. Upon inversion the band assembly is positioned around and near the terminal end of the lateral liner. Exposing the hydrophilic bands to water or other liquid causes them to swell, thereby creating the desired seal.

According to yet another aspect of the invention, an apparatus and method for positioning a liner in a cured-in-place application is provided. A band assembly is combined with the interior surface of the liner. The band assembly has two bands combined by a connecting member. The band assembly may be made from a hydrophilic, hydrophobic, or other similar impermeable compressible material that seals against entry of ground water. The bands are spaced apart from one another a sufficient distance so as to create a seal between the host pipe and the liner on opposite sides of the damaged portion of the pipe. The first and second bands are positioned generally circumferentially around the outside of the liner and the connecting members extend generally along the length of the liners between the two bands. The bands help prevent water from traveling along the length of the pipe and the connecting members help prevent water from traveling around the circumference of the pipe. This apparatus is suitable for use in both inversion-style applications and pull-in-place applications. In embodiments which use inversion, the hydrophilic bands are positioned on the outside of the liner between the host pipe and the liner. Exposing the hydrophilic bands to water or other liquid causes them to swell, thereby creating the desired seal.

### BRIEF DESCRIPTION OF THE DRAWINGS

FIG. 1 is a perspective view of a repair assembly for repairing a lateral pipe line and a main pipe line.

FIG. 2 is a perspective view of a band assembly showing two bands combined by connecting members.

FIG. 3 is a sectional view of a main pipe line and a lateral pipe line where the proximal band of the band assembly is positioned at the main/lateral pipe juncture.

FIG. 4 is a view similar to FIG. 3, but showing the liner assembly in its inflated position.

FIG. 5 is a sectional view of an embodiment where the proximal band of the band assembly is spaced a predetermined distance from the main/lateral pipe juncture.

FIG. 6 is a view similar to FIG. 5, but showing the liner assembly in its inflated position.

FIG. 7 is a sectional view of a pipe line, showing another embodiment of the present invention.

FIG. 8 is a sectional view similar to FIG. 7, showing the liner in a partially inverted position.

FIG. 9 is a sectional view similar to FIG. 8, showing the liner in a fully inverted position.

### DETAILED DESCRIPTION

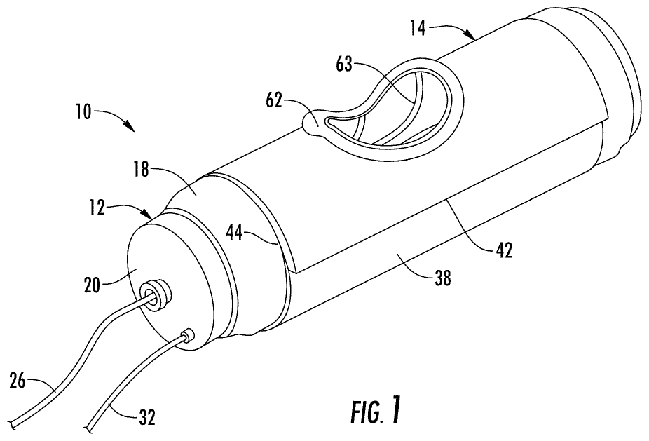

Referring to FIG. 1, a repair assembly is generally designated by the numeral 10. Repair assembly 10 includes a launcher device 12 having mounted thereto a T-shaped or Y-shaped liner assembly 14. Repair assembly 10 also houses a T-shaped or Y-shaped bladder assembly 16. In the particular configuration shown in FIG. 1, the liner assembly 14 and bladder assembly 16 are T-shaped, but they can also be Y-shaped to accommodate a lateral pipe line that intersects with a main pipe line at an oblique angle.

Launcher device 12 includes side walls 18, an end cap 20 and an end wall 22, all of which form a launcher device cavity 48. End cap 20 includes a line inlet 24 through which a line 26 extends. Line 26 is attached to a closed bladder tube end 28. Also extending through end cap 20 is an air inlet 30 which is connected to an air hose 32. T-shaped or Y-shaped bladder tube assembly 16 includes a main bladder tube 34 and a lateral bladder tube 36. Similarly, the T-shaped or Y-shaped liner assembly 14 includes a main liner member 38 and a lateral liner tube 40. The bladder assembly 16 is fitted on the interior of the liner assembly 14.

As can be seen in FIG. 1, the main liner member 38 is comprised of what is initially a flat sheet of material which is wrapped around the outside of the main bladder tube 34 and the launcher device 12. The main liner member 38 includes overlapping edges 42, 44. The launcher device 12 includes a launcher device opening 46, and the lateral liner tube 40 is contained within the launcher device cavity 48. Similarly, the lateral bladder tube 36 is contained within the cavity 14 and surrounds the lateral liner tube 40. Both the main liner member 38 and the lateral liner tube 40 are comprised of a felt layer, which is the lining surface that contacts the interior surface of the host pipe, and a polymer coating is on the opposite surface.

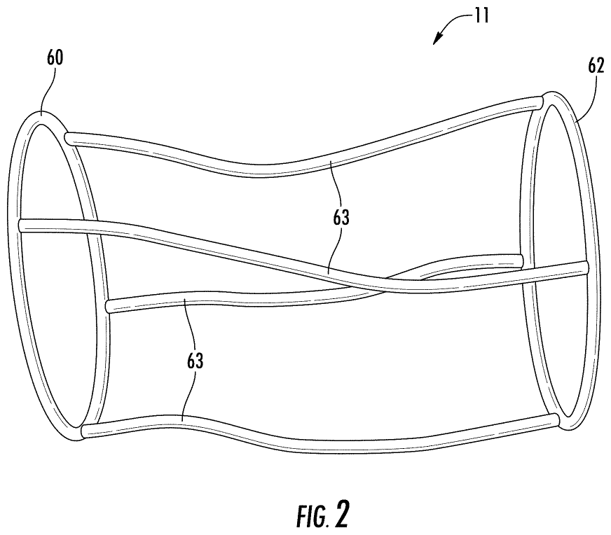

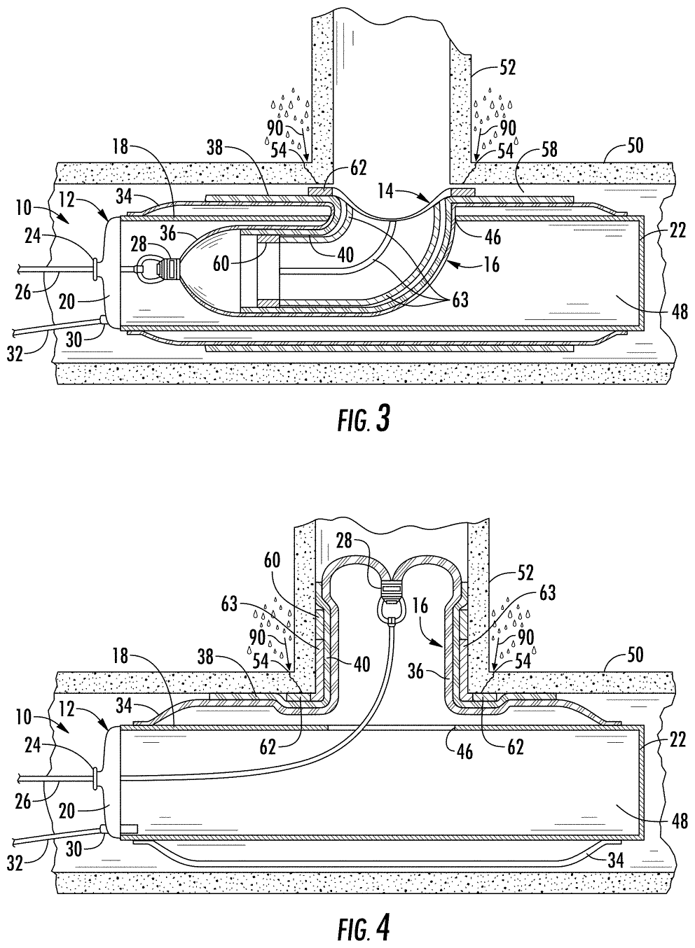

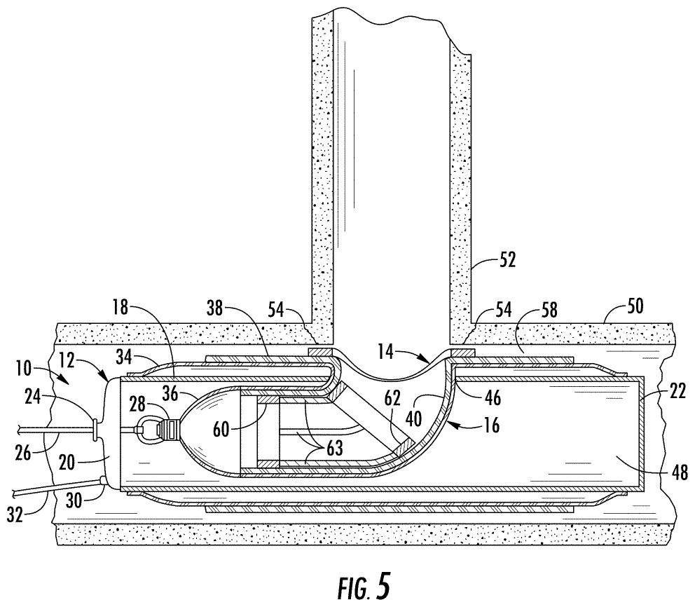

FIG. 2 shows the band assembly 11. The band assembly 11 has two bands 60, 62 combined by at least one connecting member 63. As explained below, the band assembly 11 may be positioned such that the proximal or first band 62 is on the main liner member 38 at the junction between the main/lateral pipes (FIGS. 3 and 4) and it can also be positioned around the lateral liner 40 so that it is spaced a predetermined distance into the lateral pipe 52 from the main/lateral pipe junction (FIGS. 5 and 6). The connecting members 63 are of a size and shape that they can be positioned within a liner then inverted with the liner during an inversion process. The band assembly 11 may be made from a hydrophilic, hydrophobic, or other similar impermeable compressible material that forms a seal between the liner and the wall of the pipe 50, 52, 70 to help prevent entry or movement of ground water. The band assembly 11 may be made of a material which is hydrophilic and which is capable of expanding in response to encountering ground water or other liquid. A manufacturer of such hydrophilic material is DeNeef Construction Chemical Inc., 18314 Mathes Road, Waller, Tex. 77484, under the trademark SWELLSEAL™. The bands 60, 62 help prevent water from traveling along the length of the pipe 50, 52, 70 and the connecting members 63 help prevent water from traveling around the circumference of the pipe 50, 52, 70.

The band assembly 11 is attached to the liner assembly to secure the band assembly 11 in place. The first band 62, second band 60, and connecting members 63 can be attached to the liner assembly by means of stitching, stapling, or by use of an adhesive or similar attachment means. In some embodiments it is not necessary to separately attach the second band 60 to the lateral liner 40 since the second band 60 will be connected to the first band 62 through the connecting members 63. The length of the connecting members 63 will determine the distance between the first band 62 and the second band 60.

In the embodiment shown in FIG. 2, the cross section of the two bands 60, 62 is generally round or circular in its uncompressed state. However, in other embodiments the cross section of the bands 62, 60 in its normal uncompressed state is generally rectangular (like a rubber band) so that the band 60, 62 is longer along a length than it is tall along a height. The longer generally flat side provides a larger surface area for engaging the internal surface of the pipe 50, 52, 70 relative to embodiments which use bands 60, 62 with a rounded cross section. Any of the embodiments described herein may use bands 60, 62 having any suitable shape and are not limited to the shapes shown in the figures. Further, the two bands 60, 62 of the assembly 11 do not need to have the same shape in order to function according to embodiments of the invention.

FIG. 3 shows the repair assembly 10 within a main pipe line 50 which is connected to a lateral pipe line 52. The damaged portion 54 is shown needing repair. Ground water 90 from outside the lateral pipe line 52 and the main pipe line 50 will seep through the damaged portion 54 and enter the interior of the main pipe line 50 and the lateral pipe line 52.

In order to help prevent this seepage and movement of ground water 90, a band assembly 11 is positioned about a portion of the liner assembly 14. The band assembly 11 includes a first or proximate band or gasket referred to herein as a first band 62 combined with a second or distal band 60 by connecting members 63. In embodiments wherein the first band 62 is a gasket, the gasket includes a tubular portion that extends at least partially within the lateral liner tube 40 and a flange portion that extends outwardly about the periphery of one end of the tubular portion. The first band 62 is preferably attached to the main liner member 38 around the juncture between the main liner member 38 and the lateral liner tube 40 so as to maintain the band 62 in proper position as the repair assembly 10 is positioned for operation. The second band 60 is positioned within the interior of the lateral liner tube 40. The connecting members 63 provide a predetermine spacing between the first band 62 and the second band 60. The band assembly 11 is preferably made of a hydrophilic material capable of swelling in response to being exposed to water or other liquid. However, other materials for the band assembly 11 found suitable include neoprene rubber, other similar gasket materials such as urethane or silicone rubber, and like impermeable compressible materials.

FIG. 3 shows the repair assembly 10 moved within the main pipe line 50 adjacent the lateral pipe line 52. The launcher device opening 46 is registered with a junction between a lateral pipe line 52 and the main pipe line 50. This alignment may be done with a camera (not shown). The lateral bladder tube 36 and the lateral liner tube 40 are contained within the launcher device cavity 48. It should be noted that the lateral liner tube 40, the second band 60, and most of the connecting members 63 extend within the lateral bladder tube 36 in FIG. 3; whereas, the main liner member 38 and the first band 62 remain outside the main bladder tube 34 on the exterior of the launcher device 12.

Air pressure is introduced in the cavity 48 through air hose 32, urging the liner tube assembly 14 into contact with the interior walls of the main pipe line 50 and the lateral pipe line 52. Continued air pressure causes the lateral bladder tube 36 and the lateral liner tube 40 to invert outwardly through the launcher device opening into the lateral pipe line 52 from the position shown in FIG. 3 to the position shown in FIG. 4. While air is the preferred pressurized material, other gasses or fluids may be used. It should be noted that this inversion process causes the lateral liner tube 40 to be placed on the outside of the bladder tube 36 and the band assembly 11 to be placed on the outside of the lateral liner tube 40 once the inversion is complete, as shown in FIG. 4. In this position, the first band 62 is positioned between the main liner member 38 and the interior walls of the main pipe line 50 and the second band 60 and most of the length of the connecting members 63 are positioned between the lateral liner tube assembly 16 and the interior walls of the lateral pipe line 52. Pressure within cavity 48 is maintained until the liquid hardenable material, preferably a resin activated with a catalyst, cures and hardens. This results in the liner assembly 14 assuming a rigid configuration, forming a lining to the lateral pipe line 52 and the main pipe line 50.

The ground water, as designated by the arrows 90 in FIG. 4, can seep towards the band assembly 11. However, upon encountering any portion of the band assembly 11, the water causes the assembly 11 to expand in both a radial inward direction and a radial outward direction. This causes the band assembly 11 to form a water tight seal between the T-shaped or Y-shaped liner assembly 14 and the interior walls of the main pipe line 50 and the lateral pipe line 52. Each portion of the liner assembly 11 helps prevent water seepage and movement. The first band 62 helps seal the main/lateral pipe junction. The second band 60 helps prevent water from seeping between the lateral liner 40 and the lateral pipe 52 toward the main pipe 50. The connecting members 63 help prevent water from seeping around the circumference of the lateral liner 40. In other words, the connecting members 63 help compartmentalize and trap water on a particular side of the lateral liner 40.

While the preferred embodiment of the invention is intended for use with an inversion-type application wherein the lateral bladder tube 36 and the lateral liner tube 40 invert outwardly into the lateral pipe line 52, those skilled in the art will appreciate that the band assembly 11 can also be used in pull-in-place applications. In a pull-in-place application, the band assembly 11 can be threaded down the lateral liner tube 40 to the juncture between the main liner member 38 and the lateral liner tube 40.

FIGS. 5 and 6 illustrate an alternative embodiment of the present invention wherein the band assembly 11 is combined with the lateral liner 40 in a manner similar to the previous embodiment, but neither the first band 62 nor the second band 60 are positioned on the main liner 38. In other words, the first band 62 is positioned with the lateral liner 40 at a predetermined distance from the main/lateral liner junction and the second band 60 is positioned with the lateral liner 40 at a point closer to the terminating end of the lateral liner 40. In some embodiments, after the lateral liner 40 is positioned in the lateral pipe 52 the second band 60 is positioned around the lateral liner 40 near the terminating end of the lateral liner 40 and the first band 62 is positioned around the lateral liner 40 between the terminating end of the lateral liner 40 and the main/lateral liner junction. The band assembly 11 is again preferably made of a hydrophilic material and swells in response to being exposed to water or other liquid. More specifically, the band assembly 11 expands outwardly and inwardly in a radial direction to effectively seal the area between the liner assembly and the juncture between the main pipe line 50 and lateral pipe line 52. As with the previous embodiment, the bands 60, 62 help prevent water from traveling along the length of the pipe 50, 52, 70 and the connecting members 63 help prevent water from traveling around the circumference of the pipe 50, 52, 70. This embodiment may include a sealing band or gasket at the main/lateral junction as disclosed in U.S. Pat. Nos. 6,994,118 and 8,667,991, however, those sealing members are spaced apart from and not combined with the band assembly 11.

In applications where the lateral liner tube 40 is inverted into the lateral pipe line 52, it is preferred that the first band 62 is attached to the lateral liner tube 40 to secure the band 62 in place. The first band 62 can be attached by means of stitching, stapling, or by use of an adhesive or similar attachment means. In some embodiments the second band 60 is not separately attached to the lateral liner 40 since the second band 60 will be connected via the first band 62 through the connecting members 63. The length of the connecting members 63 will determine the distance between the first band 62 and the second band 60.

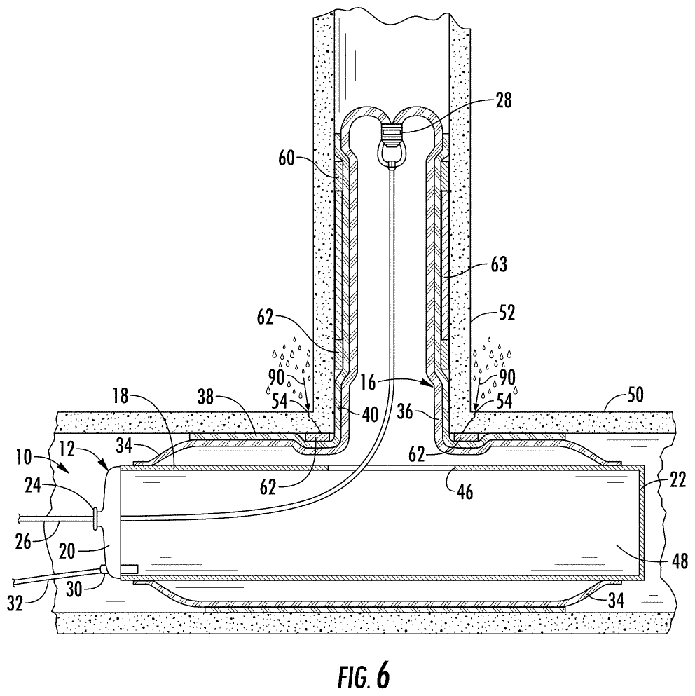

The present invention also includes an embodiment wherein the band assembly 11 can be positioned on opposite sides of a damaged portion of a pipe as shown in FIGS. 7-9. This embodiment is suitable for use in both inversion-style applications and pull-in-place applications but will be described herein with reference to an inversion-style application. FIG. 7 illustrates a singular pipe 70 having a damaged portion 72. A launcher device 92 houses a liner tube 74 and a bladder tube 84 and is positioned in the pipe 70. About the interior lining surface of the liner tube 74 the first band 62 of the band assembly 11 and the second band 60 of the band assembly 11 are spaced apart so as to be located on opposite sides of the damaged portion 72 of the pipe 70 when the bladder tube 84 and liner tube 74 are inverted. At least one of the first and second bands 62, 60 are attached to the interior lining surface of the liner tube 74 by stitching, stapling, by use of an adhesive or other suitable attachment means. The connecting members 63 connect the two bands 62, 60 and help prevent infiltration of water through the damaged portion 72 of the pipe 70.

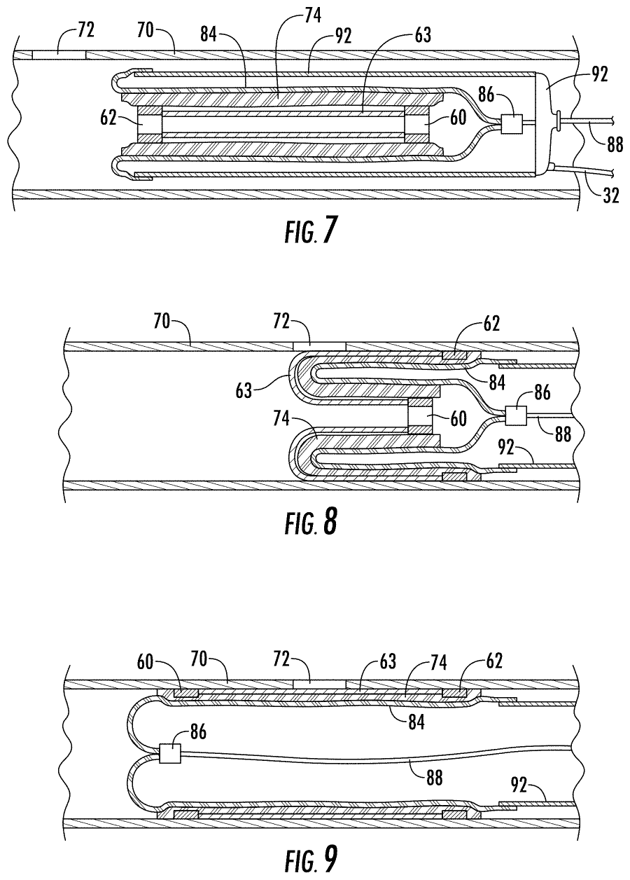

FIG. 8 shows the liner tube 74 and the bladder tube 84 is a partially inverted position.

FIG. 9 shows the liner tube 74 and the bladder tube 84 fully inverted wherein the liner tube 74 is positioned at the damaged portion 72 and the first and second bands 62, 60 are located on opposite sides of the damaged portion 72 of the pipe 70. In these instances where the lining begins a significant distance away from the launcher device, the bladder tube 84 acts as a positioning tube with the liner tube 74 positioned accordingly inside the bladder tube 84, so that the liner tube 74 does not invert until it reaches the damaged portion 72 of the pipe 70.

The liner tube 74 comprises a layer of felt-like material which is impregnated with a liquid material capable of curing and hardening and may have a polymer outside layer or coating. The bladder tube 84 is inside the liner tube 74 after inverting and includes a closed end 86 and a line 88 extending outwardly there from. Air or fluid is introduced into the interior of bladder tube 84 to urge the bladder tube 84 radially outwardly so as to urge the liner tube 74 into contact with the tube 70 being repaired. The band assembly 11 when encountered by ground water seeping through the damaged portion 72 will expand and form a water tight seal on opposite sides of the damaged portion 72. This prevents water from entering the interior of the pipe line 70.

Those skilled in the art having the benefit of this disclosure will appreciate that in some applications a single band or seal can be used to prevent ground water from entering the interior of the pipe line. For example, in lining a lateral pipe towards a main pipe, positioning a hydrophilic band at the downstream end of the liner prevents ground water from running down between the liner and pipe and emptying back into the pipe line.

The invention has been shown and described above with reference to the preferred embodiments, and it is understood that many modifications, substitutions, and additions may be made which are within the intended spirit and scope of the invention. The invention is only to be limited by the claims appended hereto.

What is claimed is:

1. A method of repairing a main pipe and a lateral pipe connected thereto and in communication therewith to form a pipe juncture, comprising:
taking a repair assembly comprising a liner assembly, the liner assembly including a main liner member and a lateral liner tube extending from the main liner member;
taking a band assembly having a first band member combined with a second band member by connecting members;
impregnating the liner assembly with a material capable of curing and hardening;
positioning the band assembly such that the first band member is disposed on the outside of the main liner member and surrounds the liner juncture forming a seal between the main liner member and the main pipe line around the pipe juncture, and the second band member surrounds the lateral liner tube and forms a seal between the lateral liner tube and the lateral pipe; and
allowing the material capable of curing and hardening to cure and harden.

2. The method of claim 1 wherein the repair assembly further comprises a bladder assembly including a main bladder tube and a lateral bladder tube extending from the main bladder tube, wherein the main liner member at least partially surrounds the main bladder tube.

3. The method of claim 2 further comprising expanding the main bladder tube under fluid pressure to press the main liner member and the first band against the main pipe near the pipe juncture.

4. The method of claim 2 further comprising expanding the lateral bladder tube under fluid pressure to press the lateral liner tube and the second band member against the lateral pipe.

5. The method of claim 1 wherein the main liner member is formed as a tube.

6. The method of claim 1 wherein the band assembly is formed from a hydrophilic material capable of swelling in response to being exposed to a liquid.

7. The method of claim 1 wherein the first band member is a gasket formed from a hydrophilic material, the gasket having a tubular portion with a first end and a second end and a flange portion extending outwardly from one of the first and second ends of the tubular portion.

8. The method of claim 2 further comprising a launcher device, the main bladder tube at least partially surrounding the launcher device.

9. The method of claim 4 wherein the lateral liner tube and second band member are positioned by expanding the lateral bladder tube to invert them through the first band member and into the lateral pipe.

10. The method of claim 2 wherein the lateral liner tube and the lateral bladder tube are pulled into the lateral pipe line.

11. A method of repairing a main pipe line and a lateral pipe line connected thereto and in communication therewith to form a pipe juncture, the method comprising:
taking a repair assembly comprising a liner assembly, the liner assembly including a main liner member and a lateral liner tube extending from the main liner member, wherein the main liner member and the lateral liner tube are combined at a liner juncture;
taking a band assembly having a first band member combined with a second band member by connecting members;
impregnating the liner assembly with a material capable of curing and hardening;
positioning the band assembly such that the first band member surrounds the lateral liner member a predetermined distance from the liner juncture and the second band member surrounds the lateral liner tube; and
allowing the material capable of curing and hardening to cure and harden.

12. The method of claim 11 wherein the repair assembly further comprises a bladder assembly including a main bladder tube and a lateral bladder tube extending from the main bladder tube, wherein the main liner member at least partially surrounds the main bladder tube.

13. The method of claim 12 further comprising expanding the main bladder tube under fluid pressure to press the main liner member against the main pipe line.

14. The method of claim 12 further comprising expanding the lateral bladder tube under fluid pressure to press the lateral liner tube and the band assembly against the lateral pipe.

15. The method of claim 11 wherein the lateral liner tube and the lateral bladder tube are pulled into the lateral pipe line.

16. The method of claim 14 wherein the lateral liner tube, first band member, and second band member are positioned by expanding the lateral bladder tube to invert them through the liner juncture and into the lateral pipe.

17. The method of claim 11 wherein the band assembly is positioned between the lateral liner tube and the lateral pipe.

18. The method of claim 11 wherein the second band member surrounds the lateral liner tube near a terminating end of the lateral liner tube.

19. A method for repairing a damaged portion of a pipe line, comprising:
taking an elongated liner tube having an interior lining surface;
taking a band assembly having a first band member combined with a second band member by connecting members;
attaching the first band to the interior lining surface of the liner tube;
impregnating the liner tube with a material capable of curing and hardening;
taking a launcher device having a launcher device opening;
inserting the liner tube at least partially within the launcher device;
inserting the launcher device into the pipe line;
inverting the liner tube through the launcher device opening to an inverted position outside the launcher device wherein the band assembly is between the pipe line and the liner tube; and
pressing the liner tube and the band assembly against the pipe line with the first and second bands on opposite sides of the damaged portion of the pipe line until the liner tube cures and hardens.

20. The method of claim 19 further comprising a bladder assembly.

21. An apparatus for repairing a main pipe and a lateral pipe connected thereto and in communication therewith to form a pipe junction, comprising:
a liner assembly comprising a main liner member and a lateral liner tube extending from the main liner member;
the lateral liner tube extendable to a position within the lateral pipe; and
a band assembly having a first band member combined with a second band member by connecting members, said first band member combined with the main liner member and surrounding a liner juncture formed between the main liner member and the lateral liner tube, the second band member surrounding the lateral liner tube, wherein the band assembly is formed from an impermeable material.

22. The apparatus of claim 21 further comprising a bladder assembly comprising a main bladder tube and a lateral bladder tube extending from the main bladder tube, wherein the main liner member at least partially surrounds the main bladder tube and the lateral liner tube is positioned between the lateral pipe and the lateral bladder tube.

23. The apparatus of claim 21 wherein the band assembly is made from a hydrophilic material capable of swelling in response to being exposed to a liquid.

24. The apparatus of claim 21 wherein the first band member is combined with the main liner member by at least one of stitching, stapling, and an adhesive.

25. The apparatus of claim 22 wherein the main bladder tube is configured to expand under fluid pressure to press the main liner member against the main pipe line and the first band member against the main pipe near the pipe junction.

26. The apparatus of claim 21 wherein the second band member is combined with the lateral liner tube near a terminal end of the lateral liner tube.

27. The apparatus of claim 21 wherein at least one of the first and second bands has a rectangular shape with a pipe engaging surface along a length that is longer than a height.

28. An apparatus for repairing a main pipe and a lateral pipe connected thereto and in communication therewith to form a pipe junction, comprising:
a liner assembly comprising a main liner member and a lateral liner tube extending from the main liner member, the main liner member and lateral liner tube combined at a liner juncture;
the lateral liner tube extendable to a position within the lateral pipe; and
a band assembly having a first band member combined with a second band member by connecting members, said first band assembly combined with the lateral liner tube a predetermined distance from liner juncture and the second band surrounding the lateral liner tube, wherein the band assembly is formed from an impermeable material.

29. The apparatus of claim 28 further comprising a bladder assembly comprising a main bladder tube and a lateral bladder tube extending from the main bladder tube, wherein the main liner member at least partially surrounds the main bladder tube and the lateral liner tube is positioned between the lateral pipe and the lateral bladder tube.

30. The apparatus of claim 28 wherein the main liner member is formed as a tube.

31. The apparatus of claim 28 wherein the band assembly is made from a hydrophilic material capable of swelling in response to being exposed to a liquid.

32. The apparatus of claim 28 wherein the first band member is combined with the main liner member by at least one of stitching, stapling, and an adhesive.

33. The apparatus of claim 29 wherein the lateral bladder tube is configured to expand under fluid pressure to press the lateral liner tube and the band assembly against the lateral pipe.

34. The apparatus of claim 28 wherein the second band member is combined with the lateral liner tube near a terminal end of the lateral liner tube.

35. The apparatus of claim 28 wherein at least one of the first and second bands has a rectangular shape with a pipe engaging surface along a length that is longer than a height.

36. An apparatus repairing a damaged portion of a pipe line, comprising:
a liner tube having an interior lining surface;
a band assembly having a first band and a second band combined by connecting members, wherein the first band is combined with the interior lining surface of the liner tube;
a launcher device having a launcher device opening;
the liner tube being at least partially within the launcher device;
the liner tube being invertible through the launcher device opening to an inverted position outside the launcher device wherein the liner tube is on the outside of the positioning tube and the band assembly is between the pipe line and the liner tube.

37. The apparatus of claim 36 wherein at least one of the first and second bands has a rectangular shape with a pipe engaging surface along a length that is longer than a height.

38. The apparatus of claim 36 further comprising a bladder assembly.

39. The apparatus of claim 36 wherein the band assembly is made from a hydrophilic material capable of swelling in response to being exposed to a liquid.

40. The apparatus of claim 36 wherein the first band member is combined with the main liner member by at least one of stitching, stapling, and an adhesive.
